(19) United States
(12) Patent Application Publication
(10) Pub. No.: US 2003/0074422 A1
(43) Pub. Date: Apr. 17, 2003

(54) Method of providing services in a wireless network

(76) Inventors: Michael P. Montemurro, Toronto (CA); Mark D. Oliver, Gerogetown (CA)

Correspondence Address: GOWLING LAFLEUR HENDERSON, Suite 2600, 160 Elgin Street, Ottawa, ON, K1P 1C3, CA

(21) Appl. No.: 09/975,008

(22) Filed: Oct. 12, 2001

(51) Int. Cl. G06F 15/16

(52) U.S. Cl. 709/219; 709/227

(57) ABSTRACT

Method and apparatus are provided for managing and delivering services to a specific location in a wireless network. A proximity management server includes a scheduler coupled to service definitions and location definitions and to a device/user directory and a policy directory. The scheduler includes a service matrix with inputs for location time, user name and device ID and inputs for content, local services and transport services. Based upon the service matrix, a list of possible services is provided to the policy block, which may have optional user and device lookup input. After applying the policy to the possible services a list of permissible services is provided to a delivery selector and transport enabler.

### FIELD OF THE INVENTION

The present invention relates to providing services in a wireless network and is particularly concerned with doing so to a specific user or device at a specific location at a specific time.

### BACKGROUND OF THE INVENTION

Wireless access standards have been defined that allows communications between portable devices, such as digital cell phones, personal data devices (PDAs), and laptops computers. For example, Bluetooth™, developed by the Bluetooth Special Interest Group, establishes a way for fixed and portable devices to communicate without wires. Certainly as the variety and number of devices has developed over time, the desire to eliminate cabling between such devices has also grown. Wireless networking has also be the focus of standardization activity with ongoing efforts such as HiperLAN2 looking at issues of high-speed transmission, security support, mobility support and automatic frequency allocation. All of these standardization efforts have been concentrating on issues of making connectivity as reliable and secure as wired connections, while ensuring the promised ease of use and freedom. However other issues remain to be addressed with regard to fully realizing the potential of such networks.

### SUMMARY OF THE INVENTION

It is an object of the present invention to provide an improved method of providing services in specific locations of a wireless network.

In accordance with an aspect of the present invention there is provided service provider operation center for providing wireless services in a proximity comprising a proximity management server including a scheduler coupled to service definitions and location definitions for deriving a schedule of availability of services in dependence upon at least one of user, device, location and time.

In accordance with another aspect of the present invention there is provided a method of providing services in wireless network comprising the steps: for a specific location, for a given device determining device specific parameters and service availability, deriving a list of services for the device, and providing the list of services to the device.

Conveniently, the step of providing the list of services to the device includes the step of applying policy with respect to the services and the device to generate a list of permissible services.

In accordance with a further aspect of the present invention there is provided apparatus for providing services in wireless network comprising: means for determining device specific parameters and service availability for a specific location and for a given device, and means for deriving a list of services for the device, and proving the list of services to the device.

Conveniently, means for providing the list of services to the device includes means for applying policy with respect to the services and the device to generate a list of permissible services.

The present invention has the advantage of providing control over delivery of service in a proximity network location.

### BRIEF DESCRIPTION OF THE DRAWINGS

These and other features of the invention will become more apparent from the following description in which reference is made to the appended drawings.

FIG. 1 illustrates a network topology in accordance with an embodiment of the present invention;

FIG. 2 illustrates in a block diagram the proximity management server of FIG. 1; and

FIG. 3 illustrates in a functional block diagram the scheduler of FIG. 2.

### DETAILED DESCRIPTION OF THE PREFERRED EMBODIMENT

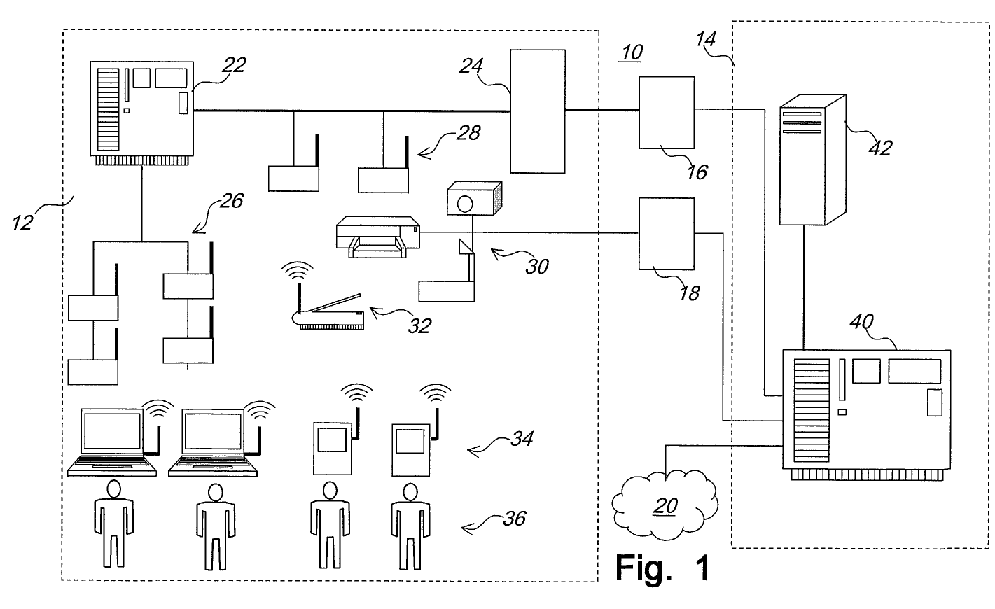

Referring to FIG. 1 there is illustrated a network topology in accordance with an embodiment of the present invention. The network topology 10 includes a proximity 12 and a service provider network operation center 14. The service provider network operation center 14 is connected to the proximity via a service provider network gateway 16 and a proximity owner network gateway 18 and to the internet 20. Proximity 12 includes an aggregation device 22 and an interface device 24. The aggregation device 22 is connected to a plurality of aggregation access points 26. While the aggregation device 22 and the plurality of free floating access points 28 are connected to interface device 24 which is connected via service provider network gateway 16 to the service provider network operating center 14. The proximity 12 also includes a number of local devices 30 hard-wire connected to the proximity owner network gateway 18 and in addition includes a plurality of local devices 32 that are connected wirelessly to the access points 26 or 28. The proximity 12 also includes a plurality of mobile devices 34 that may be used by users 36 to access the network via the aggregated access points 26 or the free floating access points 28. The service provider network operating center 14 includes a broadband aggregation device 40 and a proximity management server 42.

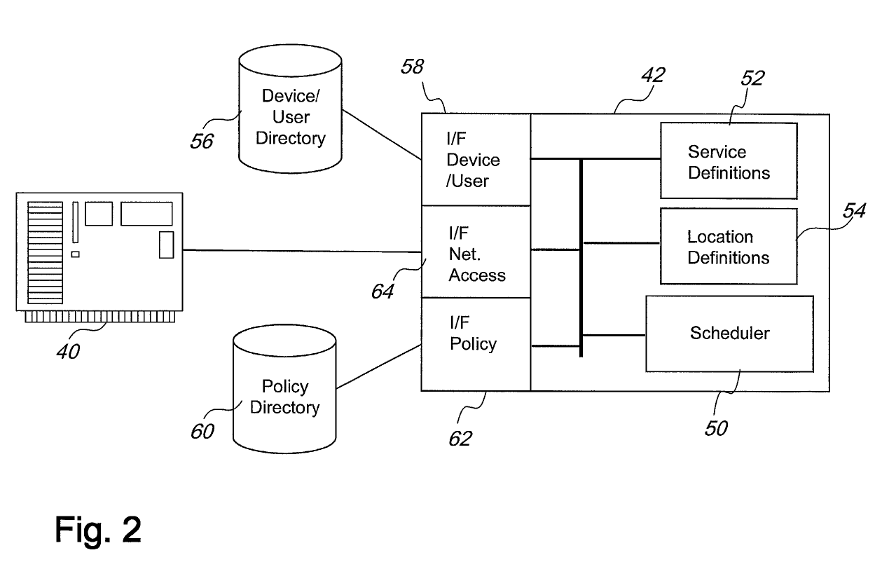

Referring to FIG. 2 there is illustrated in a block diagram the proximity management server of FIG. 1. The proximity management server 42 includes a scheduler 50 coupled to service definitions 52 and location definitions 54 and to a device/user directory 56 via an interface 58. The scheduler 50 is also connected to a policy directory 60 via an interface 62 and to the broadband aggregation device 40 via network access service interface device 64.

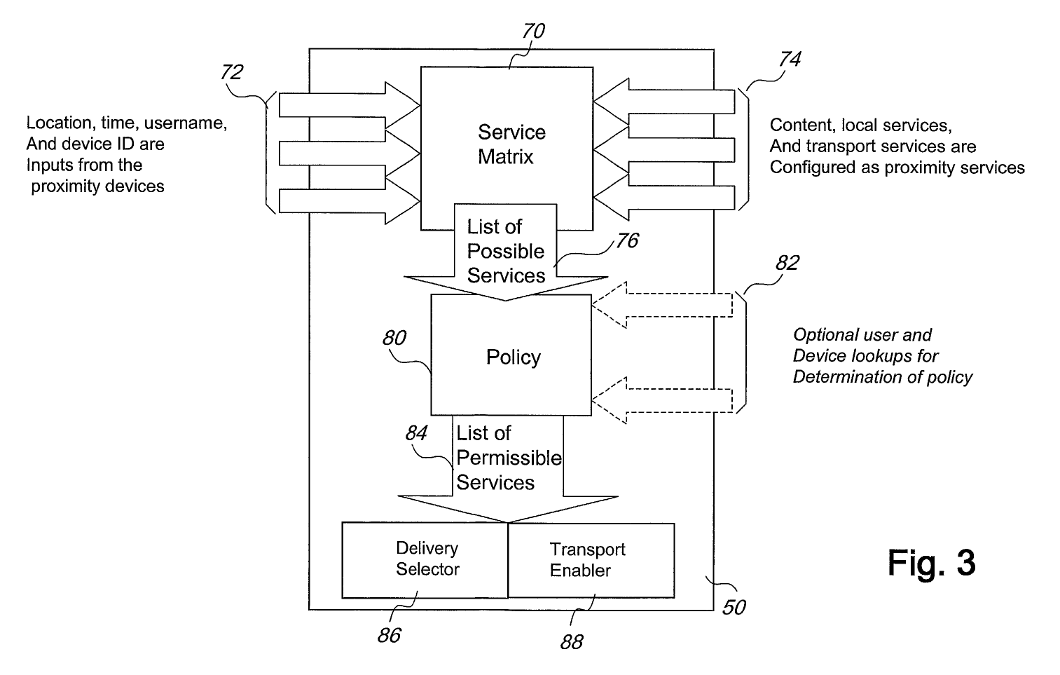

Operation of the proximity management server will be described with reference to FIG. 3, in which there is illustrated in a functional block diagram the scheduler of FIG. 2. The scheduler 50 includes a service matrix 70 with inputs 72 for location time, user name and device ID and inputs 74 for content, local services and transport services. Based upon the service matrix 70 a list of possible services 76 is provided to the policy block 80, which may have optional user and device lookup input 82. After applying the policy to the possible services a list of permissible services 84 is provided to a delivery selector 86 and transport enabler 88.

In FIG. 2, the service definition block 52 includes a service definition table having a list of defined services. The location definition block includes a location table that lists all the configured access point locations whose proximity services are provided by the proximity management server 42 and a location group table listing all logical groupings of access points. The location group table allows services to be offered to a set of grouped accessed points.

The local access points aggregated or otherwise generate key information for the proximity management server. This information includes time, location and user/device information. Services are defined in a matrix in the server. Services can be control points for local devices, links to proximity relevant sites, transport related services such as quality of service, virtual private network (VPN) and voice access to PSTN or cellular telephone networks or Internet access. Services are either transport related or content related. A list of possible services is created by matching information passed from the access points against the services defined in the matrix 70. The list of services is further reduced by applying policy against the list of services at block 80. Determination of policy may involve some lookup into a user/device database via input 82. Once the list of permissible services has been established the list must be delivered. If the services are content based, then the delivery selector chooses between several options for delivery. For example web redirector or object push. If the services are transport based then an optional module may be required to enable changes to infrastructure equipment such as switches or routers to enable the transport portion of the service. Infrastructures using a consistent policy approach such as per side policy services may not require a transport enabler. Global content services include content from a user's content providers, content from content providers that partner with service providers who install the service, and content from a third party content provider. Local content services are provided via links to web sites of proximity vendors or links to service provider provided web space, for technology challenged vendors.

The proximity management server ensures local device control via the wireless proximity network. This answers the need to have network-enabled devices offered to the wireless network. Devices such as printers, scanners, projectors and even vending machines could be controlled using portable devices within the proximity network, provided the service matrix and policy allow such control.

A number of different proximity transport services are possible, these may include virtual, private network (VPN), voice accessed PSTN or cell and internet access.

Service delivery/availability is defined from a matrix which includes: service type, location, time, and user group. Services are defined in a services table; groups of users—or individual users are defined in a user group table; locations identify the location of access points. The main scheduling table contains a list of combinations of “time, location, group and services”.

TABLE A
Example - Location Definitions

| LOCATION NAME | LOCATION DESCRIPTION |
|---|---|
| FWP_G11_N1 | Fenway Park gate 11, node 1 |
| FWP_FL_BOOTH8 | Fenway Park, Field level, concession booth 8 |
| FWP_SECTION32_34 | Fenway Park, coverage for seat sections 32- |
| | 34 |
| FWP_ADMIN | Administration Offices |
| FWP_LUXURYBOX_15 | Luxury box #15 in Fenway Park |

TABLE B
Example Groupings:

| GROUP NAME | MEMBERS |
|---|---|
| FWP Global Services | FWP* |
| FWP Seating Areas | FWP_SECTION* |
| FWP Box Seats Services | FWP_LUXURYBOX* |

TABLE C
Example Defined Services List:

| | SERVICE | | |
|---|---|---|---|
| SERVICE | DESCRIP- | SERVICE | |
| NAME | TION | TYPE | SERVICE LINK |
| McDonald's | Local Web | Web Page | http://stores.mcdonalds.com/ |
| Store #2212 | site for | | store.asp?id=2212 |
| | McDonald's | | |
| | concession | | |
| | stand | | |
| Coke | Control applet | Jini applet | Localhost/jini/coke.jin |
| machine | for Coke | | |
| #298392 | machine near | | |
| | gate 23 | | |
| Out of | Out of town | Web Page | http://www.fenwaypark.com/ |
| Town | score updates | | services/outoftown.html |
| Scores | | | |
| Internet | Unbridled | Transport | Localhost/configscripts/ |
| | Internet access | | gateway.pl |

TABLE D
Example Location/Service/Time matrix:

| Location | Service | Time |
|---|---|---|
| FWP Global Services | Scores | * |
| FWP_SEC- | McDonald's Store #2212 | <<during games>> |
| TION32_34 | | |
| FWP_SECTION32- | Coke Machine #298392 | * |
| 34 | | |
| FWP Box Seats | Internet | <<during games>> +/− |
| Services | | 2 hrs. |
| FWP_ADMIN | Internet | * |

The delivery selector identifies how the service will be presented or delivered to the client. Content services are delivered to the client via an active (user intervention is not required) or passive (user intervention is required) means. An example of an active delivery would be Object Push, where an application resident on the client device acts takes information from the infrastructure and acts on behalf of the client to launch an application. An example of passive means would be a Web Redirector or Captive Portal, where a user launches an internet browser and is presented with content based on the services that are offered to the client at a specific location and time.

Transport related services generally involve dynamic configuration of the network infrastructure based on policy decisions. In some cases (for example, phone access) the transport service could be coupled with a content service which provides an interface for the user to see what services are available and to use the service.

The configuration of services for the access points or access point concentrator would be done through a custom interface or possibly standards such as RSVP, RIP,BGP,COPS,or OSPF. A telephony interface may have to be configured using custom interface.

VPN access may be enabled by allowing the transport enabler module to force a state change in an extranet switch, virtual router, or in the routers that meter access thereto.

The Preside RADIUS (trademark of Nortel Networks) could be used to store user and policy information. Preside may also be used as an interface to modify the transport devices to provide transport services to customers.

Numerous modifications, variations and adaptations may be made to the particular embodiments of the invention described above without departing from the scope of the invention, which is defined in the claims.

What is claimed is:

1. A service provider operation center for providing wireless services in a proximity comprising:
a proximity management server including a scheduler coupled to service definitions and location definitions for deriving a schedule of availability of services in dependence upon at least one of user, device, location and time.

2. A service provider operation center as claimed in claim 1 wherein the schedule comprises a service matrix.

3. A service provider operation center as claimed in claim 2 wherein herein the service matrix includes service type.

4. A service provider operation center as claimed in claim 2 wherein herein the service matrix includes location.

5. A service provider operation center as claimed in claim 2 wherein herein the service matrix includes time.

6. A service provider operation center as claimed in claim 2 wherein herein the service matrix includes user group.

7. A service provider operation center as claimed in claim 1 wherein the scheduler includes a policy application block for modifying the available services in dependence upon a set of predetermined policies.

8. A service provider operation center as claimed in claim 7 wherein the policy application block includes database lookup to determine policy.

9. A service provider operation center as claimed in claim 8 wherein the database lookup is for a user.

10. A service provider operation center as claimed in claim 8 wherein the database lookup is for a device.

11. A service provider operation center as claimed in claim 1 comprising a network access interface coupled to an aggregation device.

12. A service provider operation center as claimed in claim 11 wherein the aggregation device includes ports for connection to at least one of a service provider gateway, a proximity owner network gateway and an internet access.

13. A method of providing services in wireless network comprising the steps:
for a specific location, for a given device determining device specific parameters and service availability;
deriving a list of services for the device; and
proving the list of services to the device.

14. A method as claimed in claim 13 wherein the step of providing the list of services to the device includes the step of applying policy with respect to the services to generate a list of permissible services.

15. A method as claimed in claim 14 wherein the step of applying policy includes the set of looking up in a database.

16. A method as claimed in claim 15 wherein the step of looking up in a database includes looking up for a specific user.

17. A method as claimed in claim 16 wherein the step of looking up in a database includes looking up for a specific device.

18. Apparatus for providing services in wireless network comprising:
means for determining device specific parameters and service availability for a specific location and for a given device, and
means for deriving a list of services for the device, and proving the list of services to the device.

19. Apparatus as claimed in claim 18 wherein means for providing the list of services to the device includes means for applying policy with respect to the services and the device to generate a list of permissible services.
